(19) United States
(12) Patent Application Publication
(10) Pub. No.: US 2017/0155886 A1
(43) Pub. Date: Jun. 1, 2017

(54) Colour-Z: Low-D Loading to High-D Processing

(71) Applicants: Derek John Hartling, London (CA); Ronnie Charles Karlstetter, St. Thomas (CA)

(72) Inventors: Derek John Hartling, London (CA); Ronnie Charles Karlstetter, St. Thomas (CA)

(21) Appl. No.: 14/928,834

(22) Filed: Oct. 30, 2015

Related U.S. Application Data
(60) Provisional application No. 62/183,970, filed on Jun. 24, 2015.

(51) Int. Cl. H04N 13/02; H04N 13/00; G06T 1/20

(52) U.S. Cl. CPC H04N 13/026; G06T 1/20; H04N 13/0007; G06T 2200/28; G06T 2200/04

(57) ABSTRACT

A proactive low dimension count to high dimension count (e.g. 2D to 3D) apparatus, using a Monitor (1) (input source/projector providing data), and Camera (2) (a purpose-built data collector) for higher dimensional computing. For example, data is loaded from a 2D monitor with existing x and y axes, while a z-axis colour encoded for depth is created through a clocked-pix progression. We define a “pix” as a single capture of the monitor signal. A pix stream is loaded from the Camera (2) into the Processor (3).

The monitor may be a physical computer monitor, television, audio/video communication device, or perspective. The camera typically uses photoreceptors to load monitor data into the camera Processor (3). The camera's output is handled by the processor and may also be characterized by Post-Processing (4), ultimately providing very high frame-rates for software applications involving rich real-time processing. During signal handling, feed-forward and feedback may dramatically enhance computational power (i.e. algorithms can be written that take advantage of the depth dimension, and signal progression analogous to depth in traditional circuit design may be accomplished—all without independent gating hardware). Post-processing may consist of a programming interface for users to communicate with the camera/processor to interpret radiation or particulate of useful character absorbed by the Camera (3), while in accordance to (dynamic/static) assigned values, functions, programs, formulae, or any combinations of these loaded/defined in the Processor (3) and in Post-Processing (4). Examples of radiation or particulate matter include electromagnetic waves, gravitational/quantum particle waves, sound or other force waves, or debris, all for the purposes of higher dimensional (namely 3D) computing.

### CROSS REFERENCE TO RELATED APPLICATIONS

This application claims priority to provisional patent application No. 62/183,970, filing date Jun. 24, 2015, titled “Colour-Z: Low-D Loading to High-D Processing.”

### BACKGROUND OF THE INVENTION

The need for computer technology continues to evolve, and there exists an inefficiency in the process of 3D rendering. Our utility may convert a 2-dimensional parallel signal into a 3-dimensional stream (Herein considered actual 3D computing). We are seeing the need of saving man years of programming by employing a higher echelon hardware architecture and physical media. While optical CPU's are in development, they suffer from the need to create physical gates for deep calculations—with the technology presented, we can reach 3 orders of magnitude faster CPU speeds for a lower manufacturing cost.

### BRIEF SUMMARY OF THE INVENTION

This novel art makes use of a monitor and camera as a data interface. Time and resource efficiency is greatly enhanced when compared to computing and programming based on traditional architecture.

The process can be accomplished live—proceeding from any lower-dimensional signal, axes combination, or plane set, into a higher basis, and this basis can include logical, semantic, and physically embedded light wave/sound/particulate central processing. When up-converting from a basic monitor through a simple digital camera, a 1000×1000 photoreceptor grid can provide data for a one million pixel array (or here after referred to as a “pix”) per clock cycle. Comparably, the CPU register size could be of size one million, unlike today's industry standard of 64. Processing can be based on any number system (binary, hexadecimal, etc.).

### BRIEF DESCRIPTION OF THE DRAWINGS

FIG. 1 depicts the physical configuration of components. The Monitor (1) connects with the Camera (2), and the Camera (2) is connected with the Processor (3). Post-Processing (4) is connected with the Processor (3). FIG. 2 is the corresponding dataflow diagram.

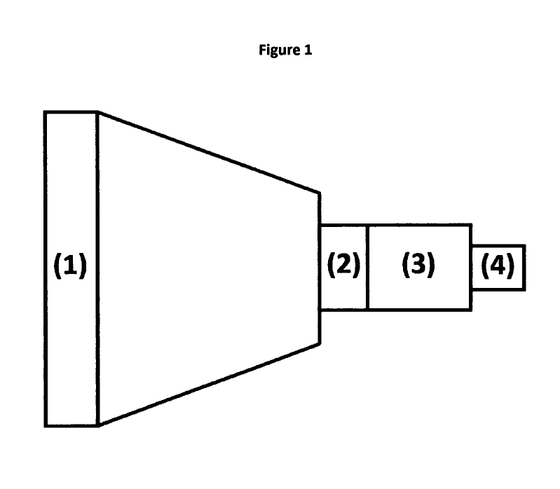

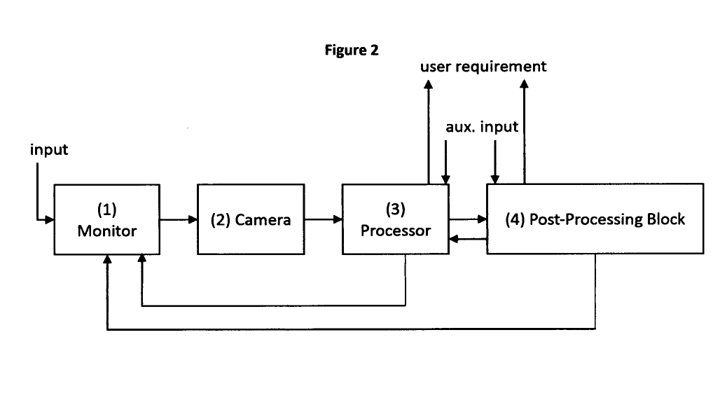

### DETAILED DESCRIPTION OF THE INVENTION

Assembly:

Referring to flowchart FIG. 2:

(1) The input signal is received by the processor through any means of transmission from a (light wave) source (e.g. one or more monitors) to a receptor (e.g. camera(s)).

(2) Each camera pix (e.g. modified receptor-array output) is loaded (usually into a cache) into the processor block (via physical or wireless connection). Each clock cycle of the processor captures each pix from the camera, originating in the monitor.

(3) Processor output can be rendered as a 3D hologram, a 2D or 3D monitor signal, or basically any multi-dimensional signal/peripheral output for further dimensional enhancing, or used as single-dimensional signal stream, traditional computing video signal, etc.

(4) Post processing can be accomplished through an embedded system or peripheral in connection with the processor.

Usage:

The system works like a computer (real-time or traditional), however, a clocked pixel array replaces parallel bit streams. Interestingly, in conjunction with processor feedback/feedforward, wave/particles from a monitor/projector can combine and interact (through the monitor/camera interface) with useful results. Furthermore, each pixel (or combination of) can be assigned logical expressions or values (i.e. clock throttles, numerical data, formulae) which allows for logical progression across a set of pix or within a pix. This process may facilitate 3D/holographic video gaming, global climate modelling, teachable industrial robots, very large and multi-dimensional numerical calculations, as well as quantum detection/control of matter including subatomic particle/wave collisions.

A single pix may be assigned thousands of large numbers, logical operators, algorithms, blocks of code, and/or embedded formulae. For linguistic applications, several alphabets and semantic formulae can be used simultaneously. Also, along with signal interaction (physically in the Monitor data-stream, or mathematically in the processor) feed-forward and feedback processing can help permit astronomical calculations at live performance levels.

### Video Gaming and Computing

Up-converting a 2D render to 3D provides a huge saving in man-years of programming, as well as in processing power requirements. The invention gives birth to a programming paradigm, involving new (compact) 3D-ready algorithms. The system may unite traditional CPU and GPU processing.

### Global Climate Modelling

With virtual stacked cubes, for example, of 1000 pix each—Low-Dimensional Loading to High-Dimensional Processing would shorten calculation times from years to days, meeting high resolution solutions and steep calculation requirements for the meteorology industry—thus allowing readily updated weather modelling.

### Industrial Robotics

By having a 3D image and perspective of the production cell, a robot can mimic the motions of a human trainer in a single pass—greatly increasing manufacturing efficiency.

### Details of Modules

Monitor

A monitor may be a traditional physical monitor, or a live viewing source for a robot, or a specified-purpose data projector, or simply an auxiliary pix-based processor output.

Camera (aka. Data Collector)

The camera(s) may be an array (multi or single layer) of photoreceptors connected directly (or wirelessly) for remote-ready processing to the processor. It may have a variety of focusing and filtration methods. A camera may be designed to receive any type of input signal (e.g. waveforms/step-signals/particles of any type). For example, astronomical, nuclear, or thermal sensing cameras may be used with an assigned processor.

Processor

The camera output could be buffered into a conventional computer system, but ideally the processor is directly coupled to each receptor on the camera array. Therefore, instead of a parallel bit stream, we have clocked pix rendering true 3D+ processing. The unit is able to capture the signal (typically electromagnetic wave patterns) and perform operations with/on it. This signal may be fed into the monitor/camera allowing cascade calculations and program threads, both with signal interaction. This allows traditional logical gating, which determines a signal's processing pathway, to be accomplished directly in a light-wave source with interaction/progression. Furthermore, control of how a photoreceptor interprets signals in contact with the array (as well as control of pix signalling) is largely defined by processing and auxiliary input, which can be modified through software and post-processing enhancement. Through processing, individual pixels of a pix can be assigned formulae and the like, as well as a physical output's wave intensity and frequency. Also, the processor can take advantage of a physical/electronic filter that actually emulates a computer algorithm or helps provide a specific application. The processor may be comprised of many systems and sub-systems to help communicate with operating systems, software/firmware/hardware, users, communication channels, etc.

Post-Processing Block

Post-Processing may be used for feeding input into the monitor/camera and is introduced due to the heady ramifications in programming. It is likely that this section is used to interface with traditional (binary only) computing.

1) A utility consisting of a Monitor (1) (input source/projector providing data), Camera (2) (purpose-built data collector), Processor (data interpreter/manipulator), and Post-Processing (4) for auxiliary system functionality. Monitor (1) data flows into the Camera (2) in the form of light, matter, or sound radiation. This information is characterized by the camera's processor (3) according to software, firmware, hardware, user requirements, and/or any input signals involved with the data stream. The Camera's Processor works with the Camera stream and together with each pix, set(s) of pix, individual pixels comprising a pix (e.g. a photoreceptor location able to provide a channel for a wave with a specific frequency and/or intensity), local or wireless definitions, or any combinations of the latter, to describe how data progresses, is manipulated, is interpreted, or receives dimensional change—to allow communication channels operating in Processing (3) and post-Processing (4) an opportunity to take advantage of a highly powerful, real-time processing system—with the possible added caveat that blocks (3) and (4) can make use of feed-forward and feedback signaling with the Monitor (1), for Camera (2) data interpretation, manipulation, progression, or dimensional change. The utility may interact with traditional CPU, GPU, RAM, cache, motherboard, etc. hardware to create character change with Processing (3) and Post-Processing (4) signals.

2) as in the apparatus described in claim 1): Monitor signals may be enhanced in their native dimensionality and when interpreted by the “Colour-Z” Low-D Loader to High-D Processor, higher dimensional (3D) computing is achieved at a physical, fundamental level.

3) as in the apparatus described in claim 1): The “local or wireless definitions” described in claim 1) in which the Processor (3) works with—may consist of (and should not be limited to): Any number of Monitor (1) or Camera (2) axes/channels; function definitions (For example, P(0)[f],0[f]=(P(0[f],0[f])+feedback-1*(P(0[f],1[f]))*t) where f is the frequency received in the pix at point P and time t), virtual or real dimensions; dimensionality constraints/enhancements; logical, semantic, syntactic, or computational operations; properties or characterization of light/sound/matter; force signal/wave; Monitor (1) specification/variable, Camera (2) specification/variable, Processor(3) specification/variable, Post-Processing (4) specification/variable, or any combination of the latter; or any combination of these mentioned definitions.

4) The Monitor (1) may be any real-time perspective (for use with robotics), step-signal, flow of radiation or particle of any character, and may have more than one output source in the utility.

5) The Camera (2) may be comprised of any combination of filters, lenses, reflectors, or photoreceptor arrays of any character, and may have more than one photoreceptor array in the utility.

6) as in the apparatus described in claim 1): The Processor (3) block or Post-Processing(4) block may interact with motherboards locally or wirelessly, and may be programmed/operated by users or communication channels working with the Post-Processing (4) interface. Processor (3) may be enhanced/developed by many systems and sub-systems to help communicate with operating systems, software/firmware/hardware, users, communication channels, external devices, other pix-based systems, and other traditional systems. Processing (3)/Post-Processing (4) Hardware/Software/Firmware dependencies or control methods may also characterize pix-based systems.

7) as in the apparatus described in claim 1): Programs that are written based on the camera processor's (3) design can be made relatively.

8), as in the apparatus described in claim 1): Higher dimensional computing by the “Colour-Z: Low-D Loading to High-D Processing” utility is not limited to 2-dimensional Monitor (1) input (e.g. a hologram may be fed into the Camera (2)).
